(19) United States
(12) Patent Application Publication
(10) Pub. No.: US 2002/0186442 A1
(43) Pub. Date: Dec. 12, 2002

(54) Multi-resolution scanning device having an auto-focus function and method therefor

(76) Inventor: Thomas Sheng, Hsin-Chu (TW)

Correspondence Address: CHARLES E. BAXLEY, ESQUIRE, Hart, Baxley, Daniels & Holton, 5th Floor, 59 John St., New York, NY, 10038, US

(21) Appl. No.: 10/081,690

(22) Filed: Feb. 25, 2002

(30) Foreign Application Priority Data
May 17, 2001 (TW) 090112052

(51) Int. Cl. G02B 26/08; H04N 1/04

(52) U.S. Cl. 359/210; 359/212; 359/223; 358/474

(57) ABSTRACT

An automatically focusing and multiple resolution scanning device which employs a final light path changing device to change the final light path of the image information. A scanning device scans the standard pattern and compares the scanned result with the image information so as to precisely focus and adjust the image information to be a correct image status. By this way, various types of resolutions can be achieved.

### FIELD OF THE INVENTION

The present invention relates to a multi-resolution scanning device having an auto-focus function, and a method for focusing for the device. In particular, the device employs changes of the light path to provide various magnifying features and resolution functions. A standard pattern is used to allow the device to automatically focus on an item.

### BACKGROUND OF THE INVENTION

There are different requirements for scanning document and films due to the scanning ranges and the requirements of resolution are different so that specific document scanner and specific film scanner are developed to meet the requirements.

However, providing lower resolution and higher resolution is the trend of the modern scanners. Taiwanese patent publish number 342158 with the title of “transmission and reflection dual-resolution scanner device”, Taiwanese patent publish number 391604 with the title of “flatbed scanner having dual-resolution scanning module (1)” and Taiwanese patent publish number 368240 with the title of “flatbed scanner having dual-resolution scanning module (1)” are examples that disclosed the use of assembly of multiple sets of light sensors and lenses to obtain the function of dual-resolution. These Taiwanese patent references also disclosed the use of reflection mirror and lenses, and the masks to change the paths of the light so as to have dual-resolution features.

The devices mentioned employ multiple sets of lenses and sensors and which increase manufacturing cost. The resolution is limited by the number of the sets of the sensors and the lenses so that the present scanners cannot meet the requirements of increase of the resolution for the needs of the market.

Besides, the distance between the lenses module and the light sensors has to be micro-adjusted when using the change of the light paths to have multiple resolutions so as to obtain better focused images. It is not satisfied to drive the parts to adjust the distance simply by using a driving device and this way cannot focus precisely.

### SUMMARY OF THE INVENTION

The primary object of the present invention is to provide a multi-resolution scanning device having an auto-focus function. The device employs a light path changing device to change the paths of light of the images and the scanning device to scan a standard pattern. A precisely focused image is obtained by micro-adjusting the scanned image according the result of the scanning of the standard pattern.

The other object of the present invention is to provide a method for automatically focusing an object by adjusting the image according a standard pattern.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an illustrative view showing the principle for obtaining an image of the present invention;

FIG. 2 is a perspective view showing the final light path changing device of the present invention;

FIGS. 3A to 3C are illustrative views showing the first light path of the final light path changing device of the present invention;

FIG. 4 is an illustrative view showing the second light path of the final light path changing device of the present invention;

FIG. 5 is a perspective view showing another embodiment of the final light path changing device of the present invention;

FIGS. 6A and 6B are illustrative views showing the third light path of the final light path changing device of the present invention;

FIGS. 7A and 7B are illustrative views showing the fourth light path of the final light path changing device of the present invention;

FIGS. 8A to 8C are illustrative views showing the fifth light path of the final light path changing device of the present invention;

FIG. 9 is an illustrative view showing the sixth light path of the final light path changing device of the present invention;

FIGS. 10A and 10B are illustrative views showing the seventh light path of the final light path changing device of the present invention;

FIGS. 11A and 11B are illustrative views showing the eighth light path of the final light path changing device of the present invention;

FIG. 12 is a perspective view showing a preferred embodiment of the scanning device;

FIG. 13 shows an embodiment of the standard pattern of the marked area on the calibration sheet;

FIG. 14 shows a flow chart of the auto-focusing method of the present invention; and

FIG. 15 shows another flow chart of the auto-focusing method of the present invention.

### DETAILED DESCRIPTION OF THE PREFERRED EMBODIMENTS

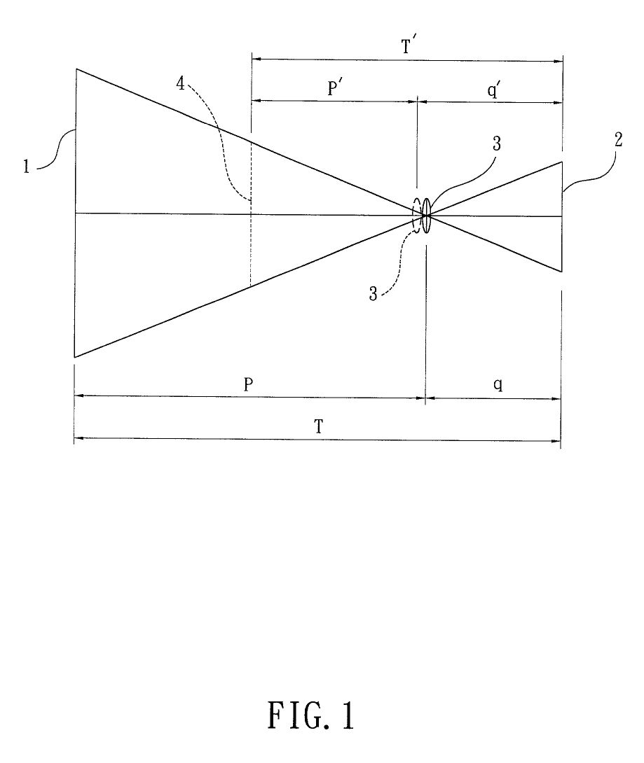

Referring to FIG. 1, the images of the original document 1 is focused onto a sensor 2 by a lens 3. The distance between an object a is designated by “p” which means a path of light between the original document 1 and the lens 3. The distance between the image and the lens 3 is designated by “q” which means a path of light between the sensor 2 and the lens 3. The focus of the lens 3 is designated by “f”. An equation for obtaining an image is expressed by 1/p+1/q=1/f. The definition of magnifying rate is M=q/p and the path of light is designated by T=p+q.

Accordingly, the magnifying rate can be increased by shortening “p” or “T”.

When “p” is shortened, the image of the original document 4 as shown by dotted lines is focused onto the sensor 2 by the lens 3 as shown by dotted lines. The magnifying rate is increased with the shortening of the distance between the original document 4 and the lens 3. In order to meet the equation mentioned above, the distance “q” between the image and the lens 3 has to be adjusted to be “q′” so as to have a better focused result.

The distance “p” is changed to be “q′”, and “p′” is less than “p”. The distance “q” between the image and the lens 3 is changed to be “q′” (the change between the q and q′ is obtained by changing the distance between the lens and the position of the final image, and q′ is close to q). The final M′(=q′/p′) is larger than the original M (=q/p).

Briefly, if the original document 1 has an 8-inch width and the sensor 2 has 9600 sensing units, the image information of the 8-inch is recorded into the 9600 sensing units and has a resolution of 1200 dpi. If the original document 4 has a 4-inch width, the image information of the 4-inch width is recorded into the 9600 sensing units to have a resolution of 2400 dpi.

The principle of the present invention is to adjust the light path to increase the magnifying rate M and the resolution, and will be described hereinafter.

Device for Changing Light Path: Light Path Changing Device

First Embodiment: To Change The Status of Light Folding Device

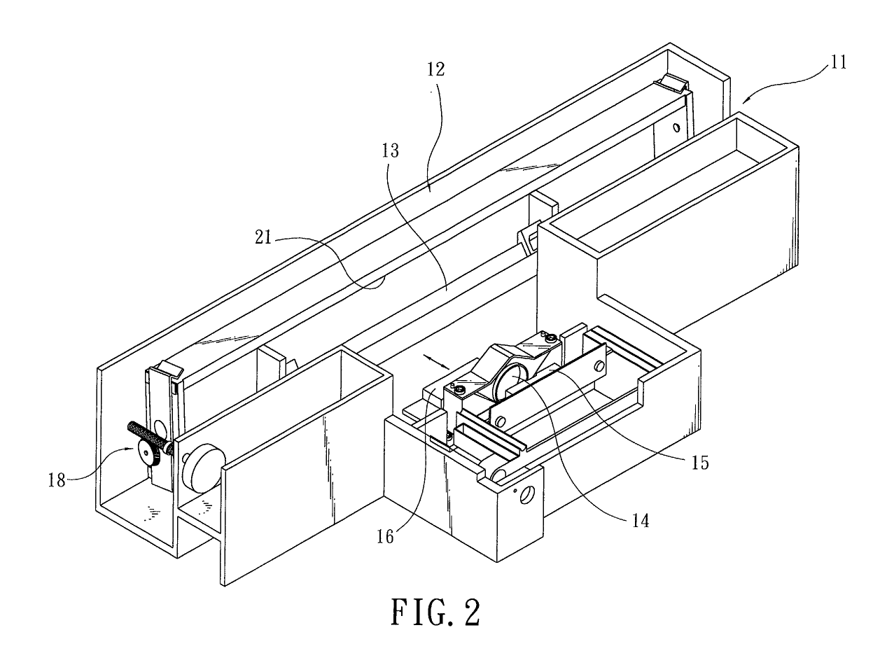

Referring to FIG. 2, a light folding device 12 is pivotally connected to a base 11 and a final reflection mirror unit 13 which includes at least one reflection mirror is located beside the light folding device 12. A lens module 14 and a sensor 15 are located in the light path of the final reflection mirror unit 13.

The light folding device 12 is snugly fixed to the base 11 by welding at one end. The light folding device 12 may also be pivotally connected to the base 11. It is noted that the light folding device 12 can be rotated relative to the base 11 even though the light folding device 12 is welded to the base 11 at one end. The lens module 14 is driven along the arrow as shown by a driving device 16 which can be a motor or a solenoid valve. The light folding device 12 is driven an angle by an angular driving device 18 which can be an assembly of a motor, a worm gear and a worm screw, an solenoid valve, or other equivalent devices).

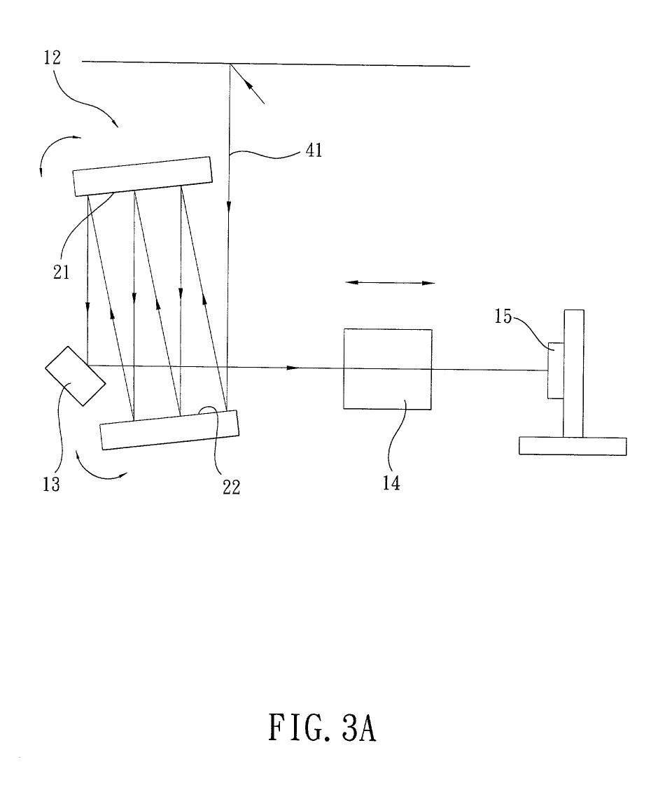

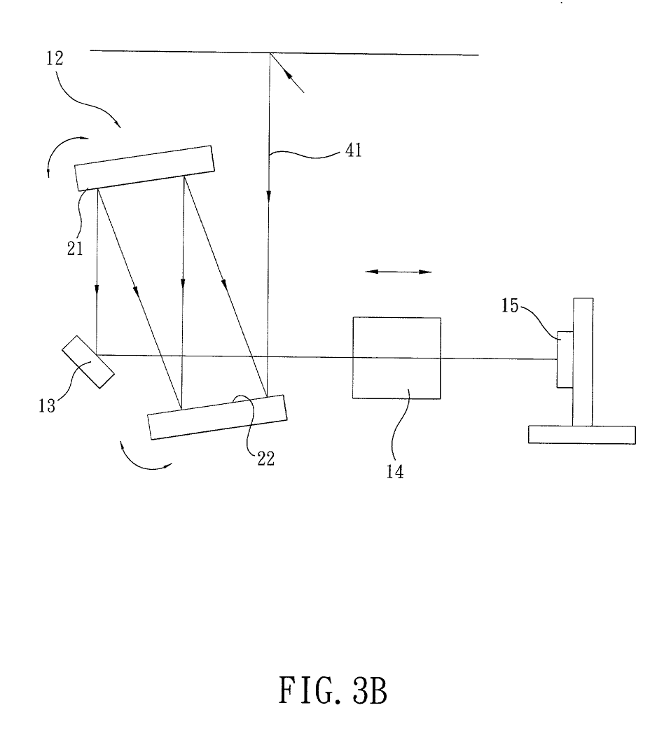

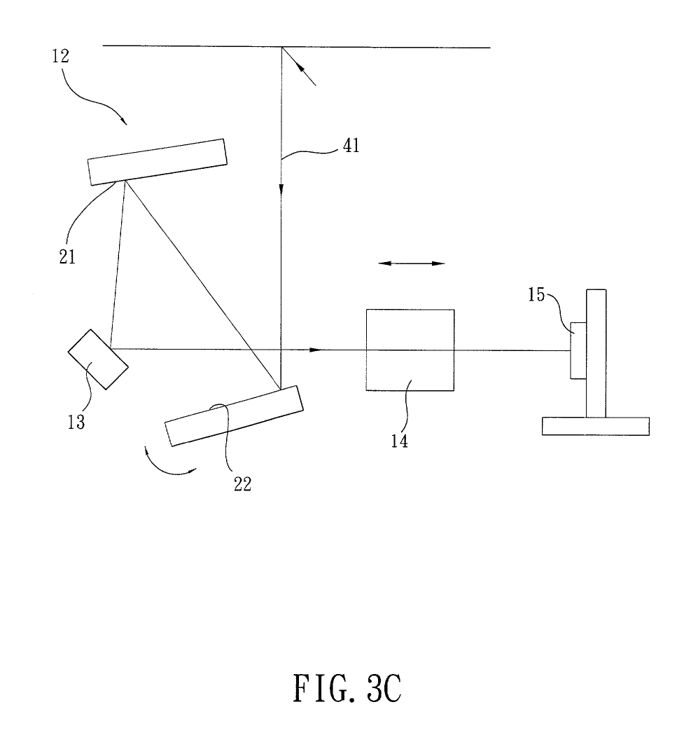

As shown in FIGS. 2 and 3A, the light folding device 12 is composed of a first reflection mirror 21 and a second reflection mirror 22 which is located in opposite to the first reflection mirror 21. The first reflection mirror 21 and the second reflection mirror 22 can be a single flat reflection mirror, and the two reflection mirrors 21, 22 face with each other.

As shown in FIG. 3A, the optical image obtained by scanning a document is defined to be the image information 41 which is introduced into the light folding device 12 so that the image information 41 is reflected between the first reflection mirror 21 and the second reflection mirror 22 of the light folding device 12.

After the image information 41 passed through the light folding device 12, it is reflected by the final reflection mirror unit 13 and received by the sensor 15 via the lens module 14.

As shown in FIGS. 2 and 3B, when the light folding device 12 is rotated by the angular driving device 18, reflection paths of the image information 41 between the final reflection mirror unit 13 and the light folding device 12 will change so as to reduce the total light path of the image information 41. The distance between the lens module 14 and the light sensor 15 has to be adjusted to have a precise focus.

Referring to FIG. 3C, the light path of the image information 41 can also be changed simply by rotating the second reflection mirror 22 in the light folding device 12.

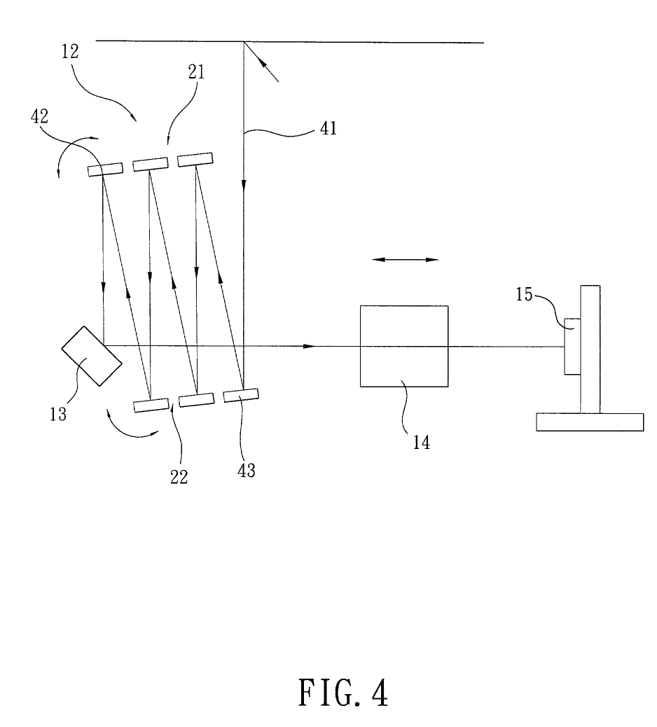

Referring to FIG. 4, the first reflection mirror 21 and the second reflection mirror 22 in the light folding device 12 can also be composed of a plurality of sub-reflection mirrors 42 and 43. The light path is adjusted by rotating the sub-reflection mirrors 42 and 43, or by rotating one of the sub-reflection mirrors 42 and 43.

The light path of the image information 41, coming from the light folding device 12 and the final reflection mirror unit 13 and reaching the lens module 14, cooperates with the distance between the lens module 14 and the sensor 15 to change the scanning resolution. This technique is familiar to one in the art and will not be described further.

The following ways can change the distance between the lens module 14 and the sensor 15:

1. to adjust either one of the lens module 14 or the sensor 15;

2. to adjust the lens module 14 and the sensor 15 simultaneously, and then to adjust either one of the lens module 14 or the sensor 15.

Second Embodiment: To Change the Status of the Final Reflection Mirror Unit

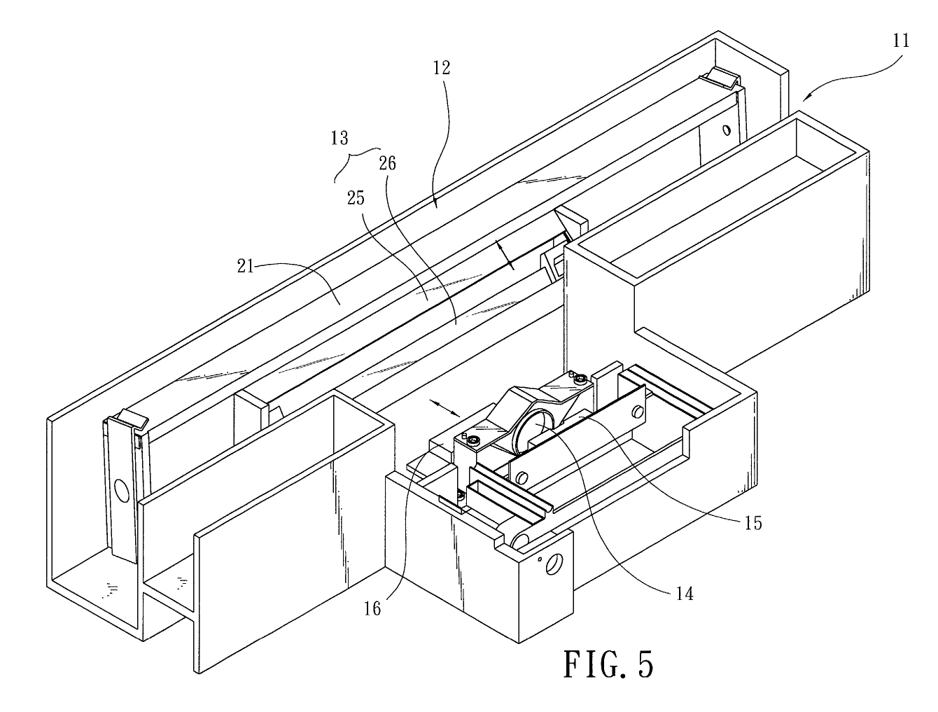

Referring to FIG. 5, a light folding device 12 is pivotally connected to a base 11 and a final reflection mirror unit 13 which includes at least one reflection mirror is located beside the light folding device 12. A lens module 14 and a sensor 15 are located in the light path from the final reflection mirror unit 13.

The light folding device 12 is snugly fixed to the base 11 by welding. The light folding device 12 may also be pivotally connected to the base 11. It is noted that the light folding device 12 can be rotated relative to the base 11. The lens module 14 is driven along the arrow as shown by a driving device 16 which can be a motor or a solenoid valve.

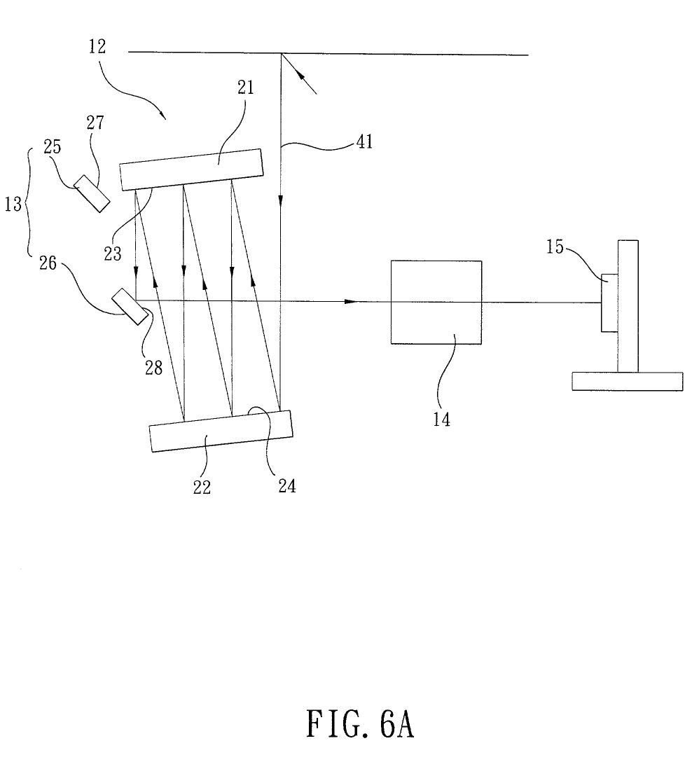

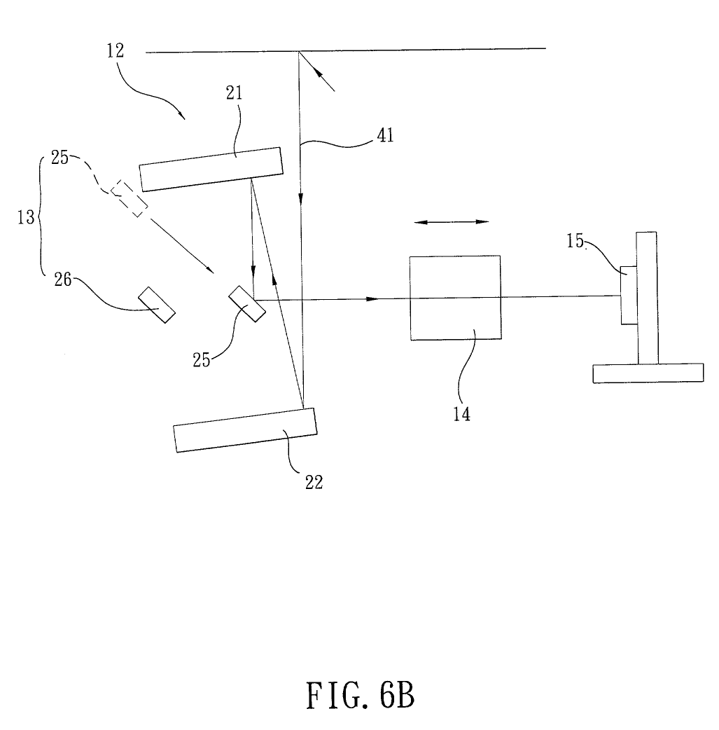

Referring to FIGS. 5 and 6A, the light folding device 12 is composed by a first reflection mirror 21 and a second reflection mirror 22 which is located in opposite to the first reflection mirror 21. The first reflection mirror 21 and the second reflection mirror 22 can be a single flat reflection mirror, and the reflection surface 23 of the first reflection mirror 21 faces the reflection surface 24 of the second reflection mirror 22.

The final reflection mirror unit 13 is composed of a first reflection mirror 25 and a second reflection mirror 26 (the first reflection mirror 25 and the second reflection mirror 26 are regarded as the final reflection mirror unit 13). The first reflection mirror 25 is driven by a solenoid valve, a motor, or other equivalent devices (not shown) to be movably installed beside the light folding device 12. The reflection surface 27 of the first reflection mirror 25 faces the light folding device 12. The second reflection mirror 26 is fixedly positioned beside the light folding device 12. The reflection surface 28 of the second reflection mirror 26 faces to the light folding device 12 and the lens module 14 at a fixed angle.

As shown in FIG. 6A, the optical image obtained by scanning a document is defined to be the image information 41 which is introduced into the light folding device 12 so that the image information 41 is reflected between the first reflection mirror 21 and the second reflection mirror 22 of the light folding device 12.

After the image information 41 passed through the light folding device 12, it is reflected by the second reflection mirror 26 and received by the sensor 15 via the lens module 14.

As shown in FIGS. 6B, when the first reflection mirror 25 of the final reflection mirror unit 13 is moved in front of the reflection surface of the second reflection mirror 26 as shown in the drawing, reflection paths of the image information 41 in the light folding device 12 will change so as to reduce the total light path of the image information 41. The distance between the lens module 14 and the light sensor 15 has to be adjusted to have a precise focus.

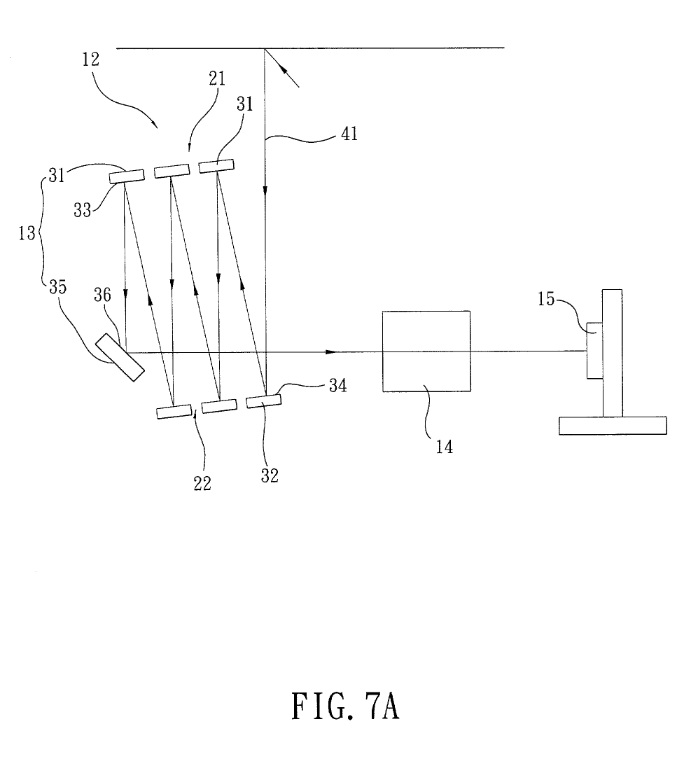

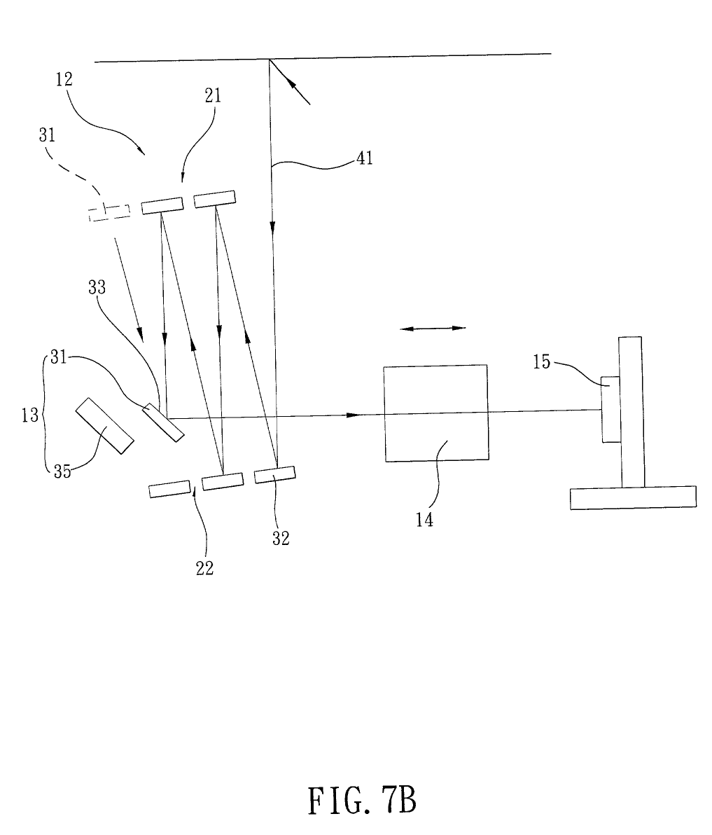

Referring to FIGS. 7A and 7B, the first reflection mirror 21 in the light folding device 12 is composed of a plurality of sub-reflection mirrors 31. The second reflection mirror 22 in the light folding device 12 is composed of a plurality of sub-reflection mirrors 32. The sub-reflection mirrors 31 and 32 are located in opposite to the reflection surfaces 33 and 34. The final reflection mirror unit 13 is composed of a sub-reflection mirror 31 and reflection mirror 35. When the status of the final reflection mirror unit 13 is changed, the sub-reflection mirror 31 of the final reflection mirror unit 13 is moved to the position as shown in FIG. 7B so as to change the light path of the image information 41.

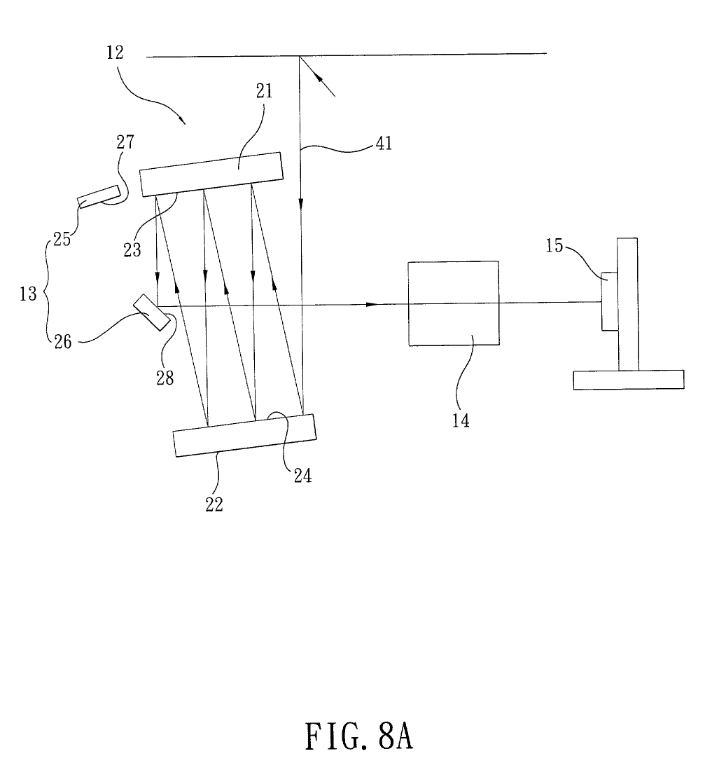

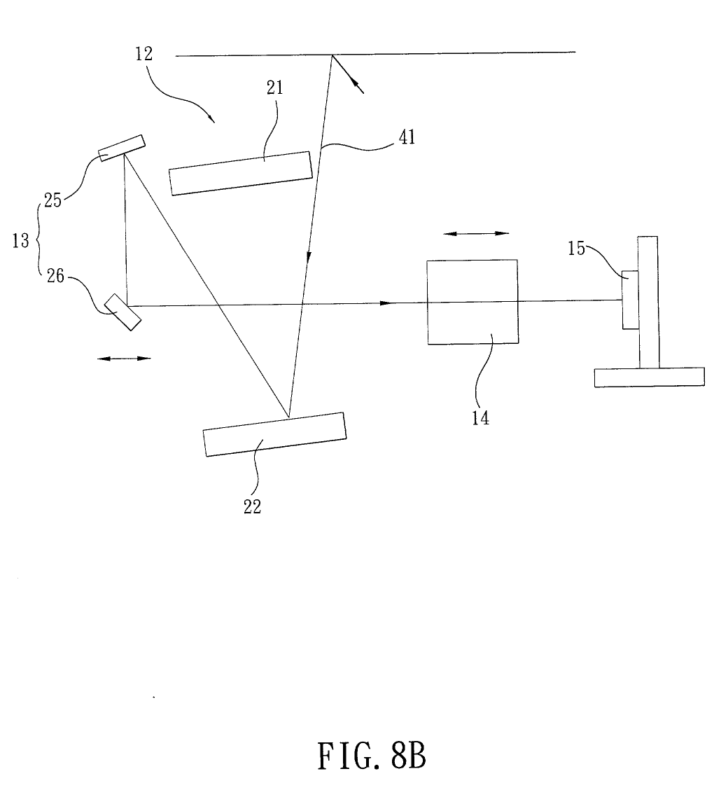

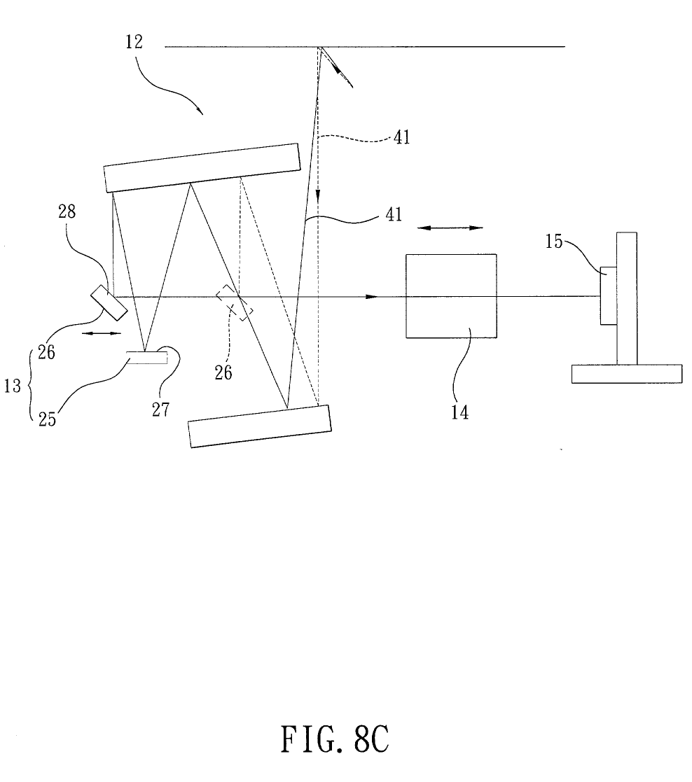

As shown in FIGS. 8A, 8B and 8C, the final reflection mirror unit 13 is composed of a first reflection mirror 25 and a second reflection mirror 26. The change of the relative positions between the two reflection mirrors 25 and 26 can adjust the light path of the image information 41.

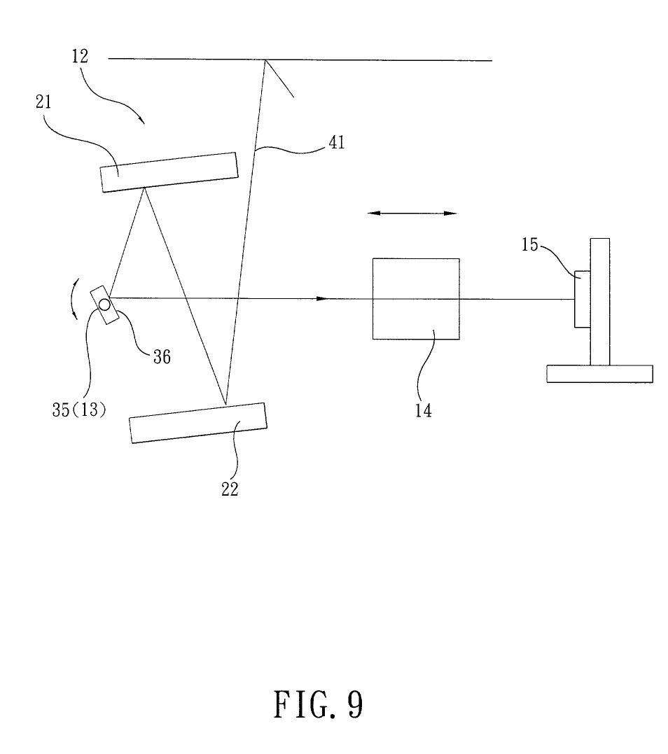

FIG. 9 shows that the final reflection mirror unit 13 is composed of a reflection mirror 25 and the image information 41 is reflected from the reflection surface 36 to the lens module 14 by rotating the reflection mirror 35 to adjust the light path of the image information 41.

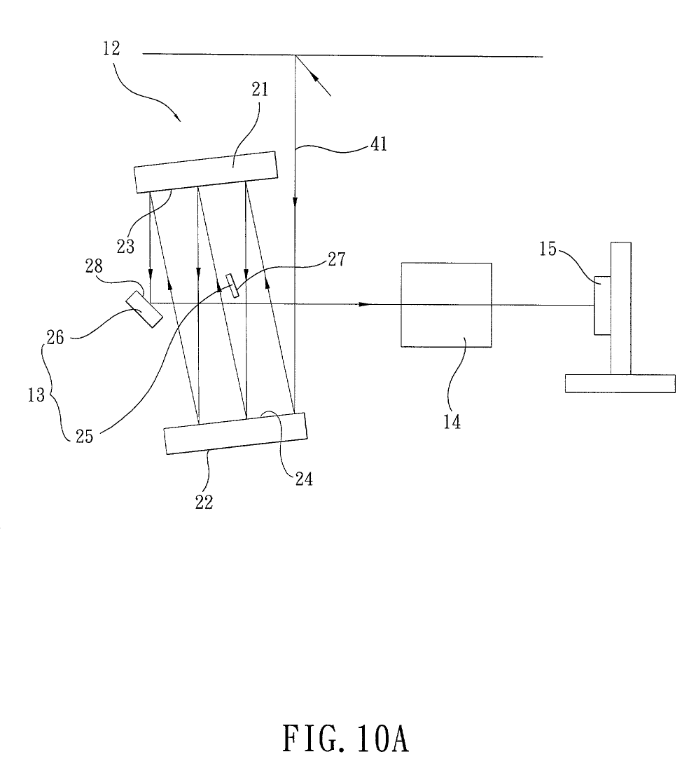

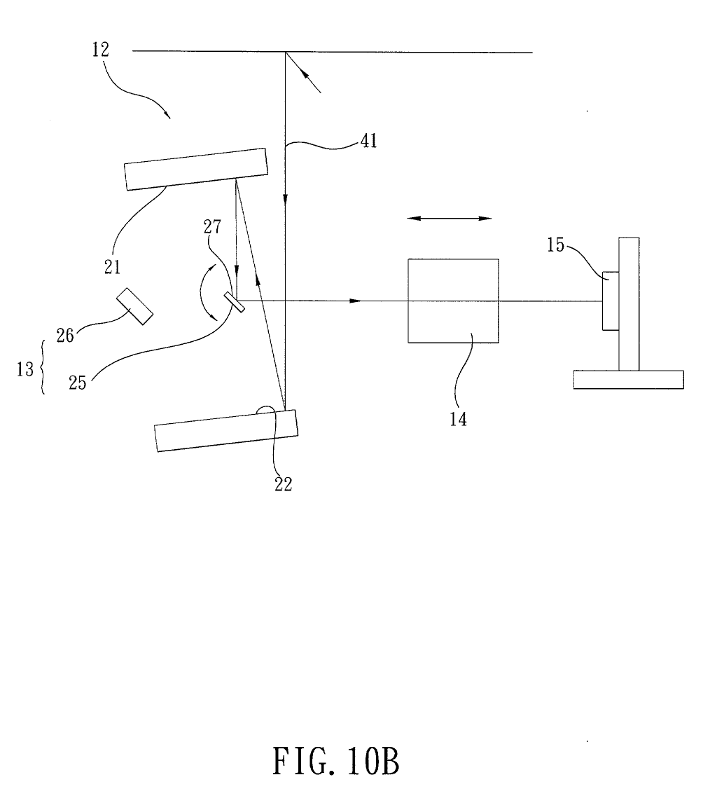

FIGS. 10A and 10B show that the final reflection mirror unit 13 is composed of a movable first reflection mirror 25 and a fixed second reflection mirror 26. The first reflection mirror 25 is located between the first reflection mirror 21 and the second reflection mirror 22. When the light path is adjusted, the first reflection mirror 25 is rotated to the position shown in FIG. 10B to let the image information 41 be reflected from the reflection surface 27 to the lens module 14.

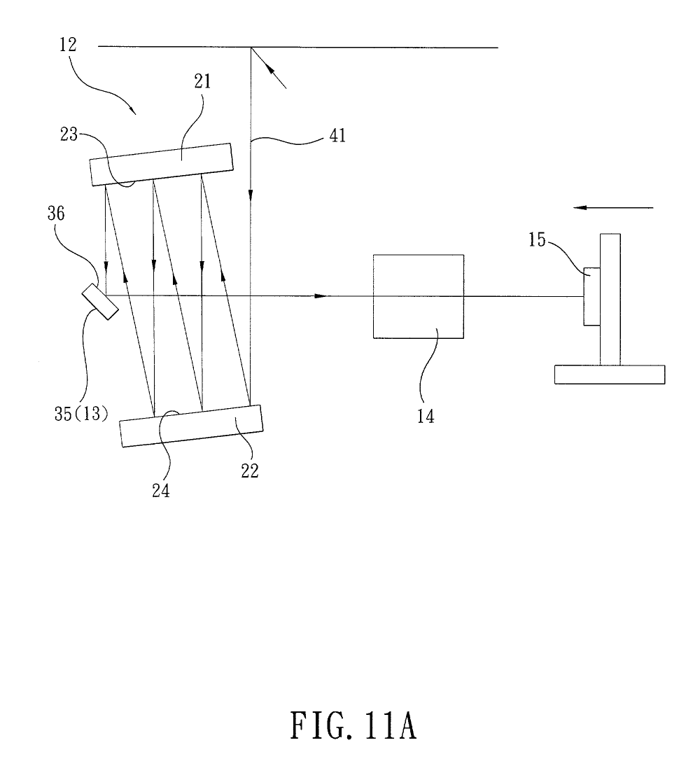

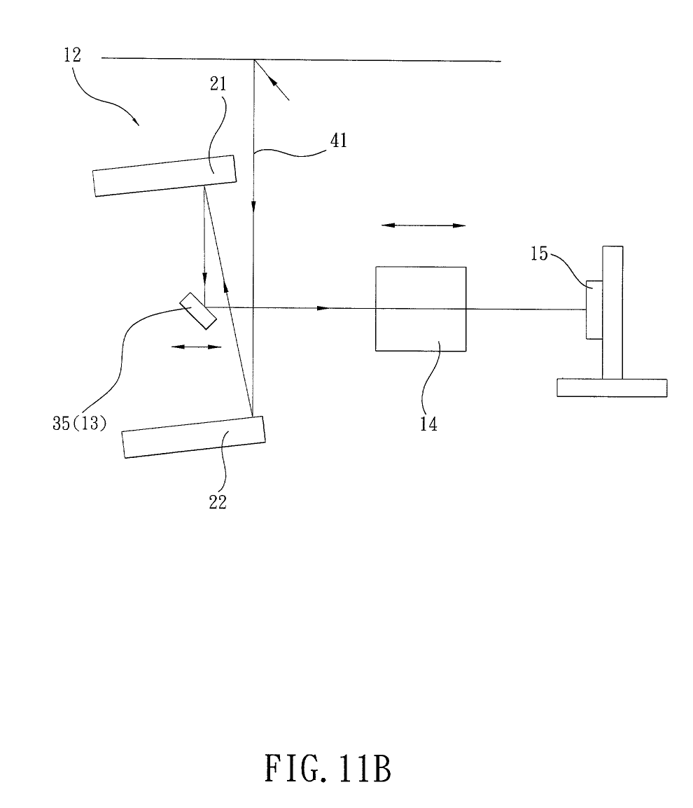

Referring to FIGS. 11A and 11B, the final reflection mirror unit 13 can be composed of a movable reflection mirror 35 so that the final reflection mirror 35 may be moved to adjust the light path of the image information 41.

Besides, the following ways can be employed to adjust the distance between the lens module 14 and the sensor 15:

1. to adjust either one of the lens module 14 or the sensor 15;

2. to adjust the lens module 14 and the sensor 15 simultaneously, and then to adjust either one of the lens module 14 or the sensor 15.

Furthermore, in addition to adjusting the distance between the lens module 14 and the sensor 15, using a lens module having variable focus can also achieve the same function.

Structure and Method to Automatically Focus

1. Structure:

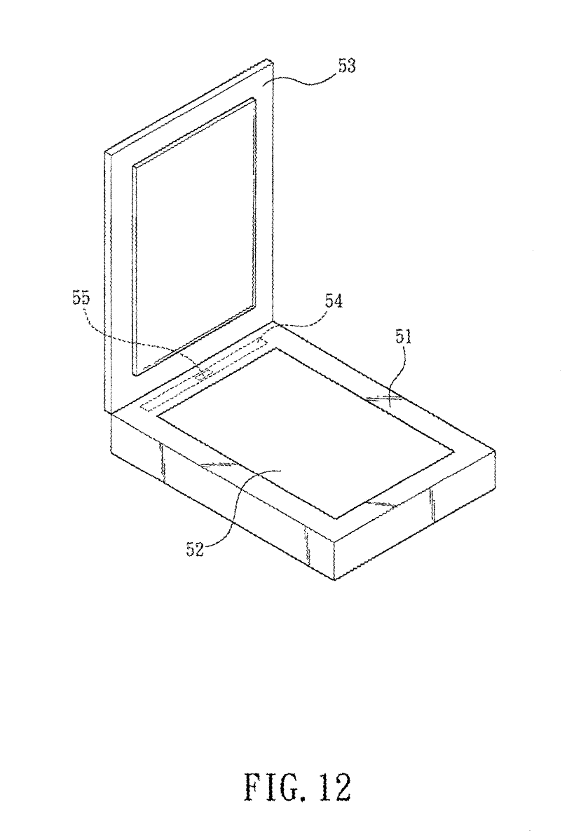

Referring to FIG. 12, the scanner is a preferred embodiment of the present invention. The scanner includes a casing 51, a scanning platform 52, a top cover 53, a calibration sheet 54, and a marked area 55. The calibration sheet 54 is received in the casing 51 and, for those who familiar to the related knowledge, the calibration sheet 54 is used to correct or compensate for the color and brightness of the scanning light source (not shown) in the scanner. There is a specific pattern on the calibration sheet 54 and which is used to judge the start point of the scanning.

Nevertheless, besides the purposes mentioned above, the calibration sheet 54 of the present invention has the marked area 55 for convenience of automatically focusing.

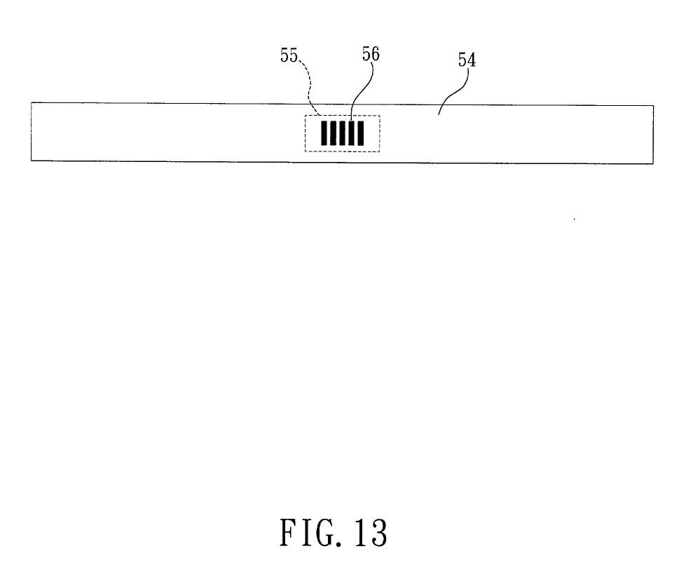

FIG. 13 shows the embodiment of the standard pattern 56 in the marked area 55 on the calibration sheet 54. However, it is not the limitation of the scope of the present invention, any known pattern, even the colorful pattern is located in the scope of the pattern 56 of the present invention.

In addition to the standard pattern 56 as mentioned above, the database can be established in which the physical characters of the standard pattern 56 such as color, brightness, contrast and sizes, and the extreme acceptable values (pre-set range) of the physical characters are received.

2. Method for Automatically Focusing

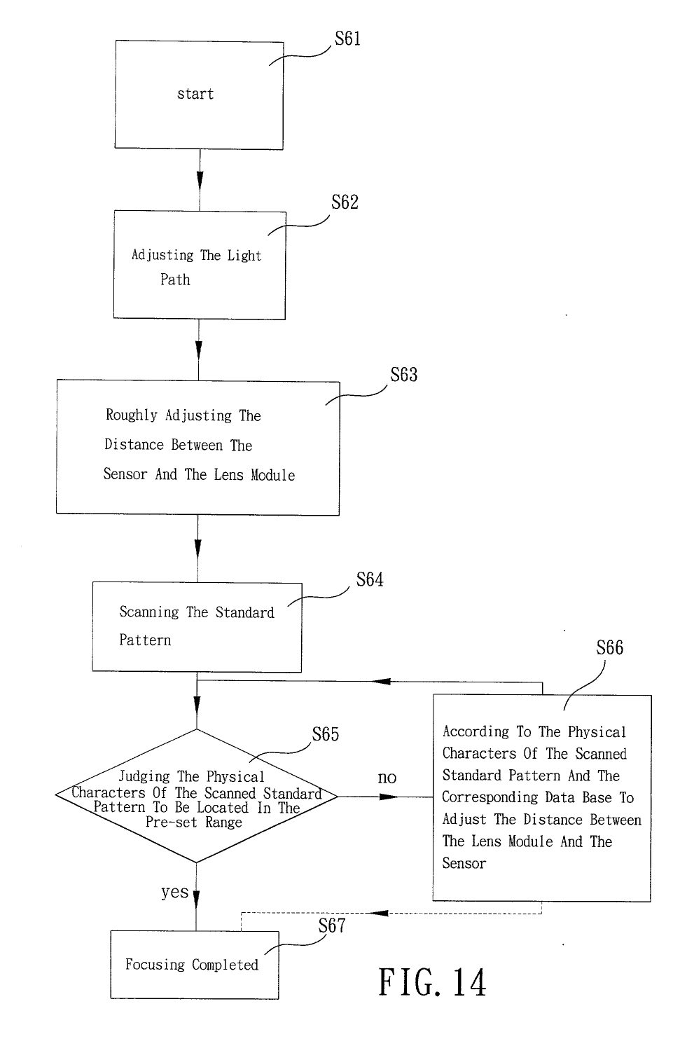

FIG. 14 shows the flow chart of the method for automatically focusing of the present invention.

Step S61: Starting to scan.

Step S62: Adjusting the light path by adjusting the positions or the angles of the light folding device 12 or the final reflection mirror unit 13. In other words, to change the number of reflection times of the image information 41 in the light folding device 12 and the final reflection mirror unit 13.

Step S63: Responsive to the adjustment in the step 62, the distance between the sensor 15 and the lens module 14 is roughly adjusted.

Step S64: Scanning the standard pattern 56 to obtain the physical characters of the standard pattern 56.

Step S65: Judging the physical characters (such as width, color, brightness) of the scanned standard pattern to be located in the pre-set range.

Step S66: if the result from step S65 is NO, adjusting the distance between the sensor 15 and the lens module 14 according to the physical characters and the information in the database.

Step S67: if the result from step S65 is YES, the action of focusing is finished.

It is to be noted that the route can be returned to step S65 as shown in the solid route line after the step S66 is finished so as to proceed even more precise adjustment, or directly skip to step S67 as shown in dotted route line so as to save time.

For instance, the following is a description for proceeding the step S65 for the physical characters (such as color, brightness, contrast) of the standard pattern.

Referring to FIG. 13 again, the standard pattern 56 has multiple lines and if the standard pattern 56 is not properly focused, the physical characters between the two lines on the sensor 15 will not the same as the experimental or theoretical value. The experimental or theoretical value can be set by the manufacturers and memorized as a database. The range around the experimental value can also be set by the manufacturers and is memorized as a database. Therefore, it is convenient for the scanner to adjust the parts by using the database.

In addition, the database may have the distance (or the reference for adjusting the zoom lens) between the lens module 14 and the sensor 15 corresponding to the physical characters of the result scanned by the sensor 15. An example is provided in Table 1:

TABLE 1

| The physical characters of the result | the distance between the lens |
|---|---|
| scanned by the sensor | module and the sensor |
| A1 | B1 |
| A2 | B2 |
| A3 | B3 |
| . . . | . . . |
| An | Bn |

By this way, the focusing process can be easily finished.

It is noted that the marked area 55 is not necessarily located on the center of the calibration sheet 54, the marked area 55 can also be located on two sides or any position. The standard pattern 56 is not necessarily straight lines, any known algebra pattern can also be acceptable.

It is noted that the marked area 55 is not necessarily located on the center of the calibration sheet 54, it can also be located in the casing or on the glass plate.

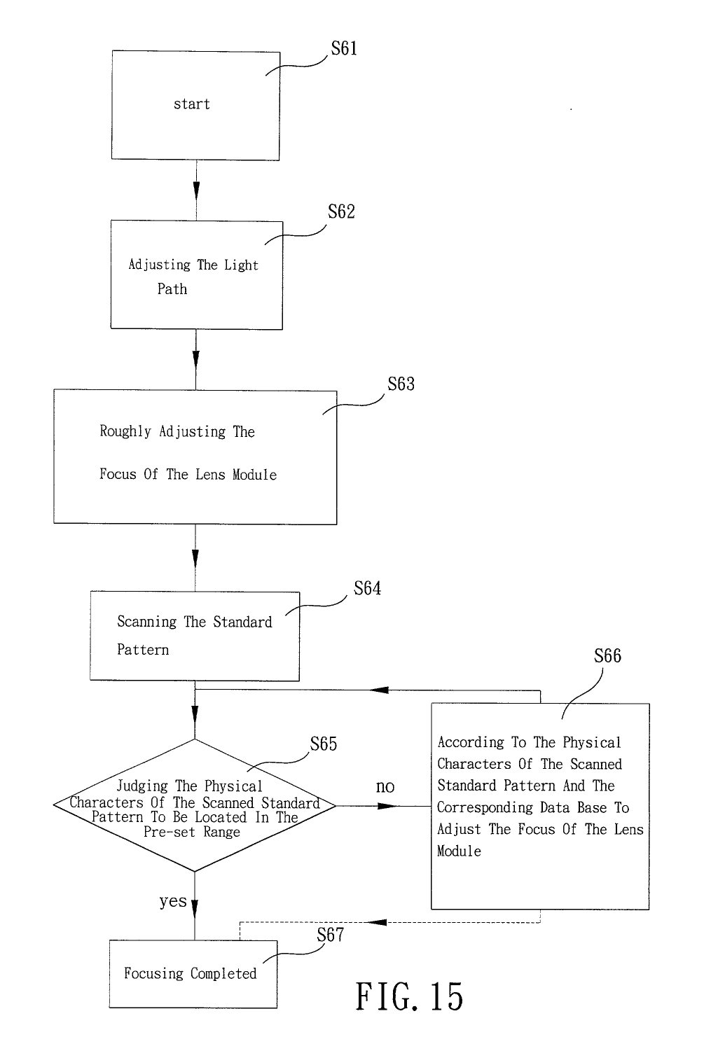

Referring to FIG. 15, another focus method is provided in the flowing chart. In the embodiment, a zoom lens module is employed so that the step S63 and step S66 are different from those in FIG. 14. This embodiment uses the adjustment of the focus distance of the lens module to replace the adjustment of the distance between the lens module and the sensor. It is understandable for those skilled persons in the art. The rest of the steps are the same as shown in FIG. 14.

The structure and the method employ a standard pattern on the scanner to proceed the function of automatically focusing. The function of the automatically focusing is not necessarily limited in increasing resolution and can be used in reducing resolution.

In order to define clearly in the following claims, the light folding device 12 and the final reflection mirror unit 13 are termed as a final light path changing device. The final light path can be changed by changing the light folding device 12 and the final reflection mirror unit 13. For those skilled persons in the art, other final light path changing device can be used besides the light folding device 12 and the final reflection mirror unit 13.

While we have shown and described the embodiment in accordance with the present invention, it should be clear to those skilled in the art that further embodiments may be made without departing from the scope of the present invention.

What is claimed is:

1. An automatically focusing and multiple resolution scanning device for processing an image information obtained by scanning document, comprising:
a final light path changing device which receives the image information and changes the number of reflection of the image information in the final light path changing device;
a lens module receiving the image information from the final light path changing device and focusing to the image information;
a sensor receiving the focused image information, and
a standard pattern located in the scanning device and scanning the standard pattern when the final light path being changed so as to obtain physical characters of the scanning, the focusing of the scanning device being adjusted according to the obtained physical characters.

2. The scanning device as claimed in claim 1, wherein the final light path changing device comprises a light folding device which has a first reflection mirror and a second reflection mirror which is located in opposite to the first reflection mirror, the image information being introduced in the light folding device and reflected between the first reflection mirror and the second reflection mirror, a final reflection mirror unit having at least one reflection mirror so as to receive the image information from the light folding device.

3. The scanning device as claimed in claim 2, wherein the final light path changing device changes the final light path by changing the number of reflection of the image information in the light folding device.

4. The scanning device as claimed in claim 3 wherein the light folding device comprises a first reflection mirror and a second reflection mirror, at least one of the first reflection mirror and the second reflection mirror being movable.

5. The scanning device as claimed in claim 2 wherein the final light path changing device changes the final light path by changing an angle between the final reflection mirror unit and the standard pattern.

6. The scanning device as claimed in claim 2, wherein the final light path changing device changes the final light path by changing a distance between the final reflection mirror unit and the standard pattern.

7. The scanning device as claimed in claim 5, wherein the final reflection mirror unit comprises a fixed reflection mirror and a movable reflection mirror.

8. The scanning device as claimed in claim 5, wherein the final reflection mirror unit is composed of one movable reflection mirror.

9. The scanning device as claimed in claim 6, wherein the final reflection mirror unit comprises a fixed reflection mirror and a movable reflection mirror.

10. The scanning device as claimed in claim 6, wherein the final reflection mirror unit is composed of one movable reflection mirror.

11. The scanning device as claimed in claim 1, wherein the focusing status of the scanning device is adjusted by adjusting the lens module and the sensor.

12. The scanning device as claimed in claim 1, wherein the focusing status of the scanning device is adjusted by adjusting a zoom lens module.

13. A method for focusing for an automatically focusing and multiple resolution scanning device, comprising the following steps:
adjusting a final light path of an image information in the scanning device;
adjusting a distance between a lens module and a sensor;
scanning a standard pattern in the scanning device so as to obtain physical characters of the standard pattern; and
adjusting a distance between the lens module and the sensor according to the physical characters.

14. The method as claimed in claim 13 further comprising the following step which is to judge whether the physical characters of the scanned standard pattern located in a pre-set range.

15. A method for focusing for an automatically focusing and multiple resolution scanning device, comprising the following steps:
adjusting a final light path of an image information in the scanning device;
adjusting a focus distance of a lens module;
scanning a standard pattern in the scanning device so as to obtain physical characters of the standard pattern; and
adjusting a focus of the lens module.

16. The method as claimed in claim 15 further comprising the following step which is to judge whether the physical characters of the scanned standard pattern located in a pre-set range.
